(19) United States
(12) Patent Application Publication
(10) Pub. No.: US 2011/0221137 A1
(43) Pub. Date: Sep. 15, 2011

(54) SEALING METHOD AND APPARATUS

(76) Inventors: Udoka Obi, Aberdeen (GB); Nicholas John Ryan, Aberdeenshire (GB)

(21) Appl. No.: 13/129,856

(22) PCT Filed: Nov. 20, 2009
(86) PCT No.: PCT/GB09/51583

§ 371 Date: May 18, 2011

(30) Foreign Application Priority Data
Nov. 20, 2008 (GB) 0821222.7
Aug. 17, 2009 (GB) 0914341.3

(51) Int. Cl. E04B 1/682; F16J 15/10

(52) U.S. Cl. 277/316; 277/602; 277/627

(57) ABSTRACT

A sealing element is described which is adapted to perform partial extrusion through an opening in a pipe wall. A method of sealing an opening (2) in a vessel or pipe comprises the steps of introducing a sealing element (5) into the vessel or pipe upstream of the leak (2), transporting the sealing element to the opening (2) and allowing the sealing element to at least partially extrude through the opening (2).

The present invention relates to a sealing method and apparatus and more specifically to a method and apparatus for sealing openings such as leaks, fractures, holes, cracks fissures or the like in a vessel such as a tubular member and more specifically a duct or pipe and also to a method and apparatus for sealing openings such as perforations in a vessel such as a tubular member and more specifically a pipe or casing.

During recovery of fluids such as liquids and gases, and particularly hydrocarbons including oil and gas from subsea and subterranean reservoirs, a well is sunk into reservoir and a tubing string is introduced into the well to provide a path for the flow of fluids from the reservoir to the surface for recovery and processing. Once the tubing reaches the required depth within the reservoir, perforations are made through the casing wall to allow well fluids to pass into the tubing from where they can be pumped or otherwise directed to the surface.

The constitution of the fluids in the reservoir change depending upon the depth within the reservoir. For example, in a reservoir containing a mixture of oil and water, the oil will float above the water and therefore perforations in the tubing which are above the water level will produce oil whereas perforations below the water level will produce water.

As the oil is removed from the reservoir, water seeps through the surrounding rock formations and the reservoir begins to fill up with water. Therefore, the level of water in the reservoir rises pushing the remaining oil to the top such that gradually the perforations from the bottom of the casing upwards change from producing oil to producing only water.

Selectively blocking the perforations at a required depth allows the operator to limit the amount of water being produced through the well and therefore maximise the hydrocarbon content of the produced fluids.

Known sealing elements include balls and spheres which can be introduced into the casing to block the lower perforations for example by selecting the density of the spheres to ensure that the appropriate depth of perforations are blocked.

However, such known sealing elements are used to limit the flow of treatment chemicals passing through the perforations from the inside of the tubing into the formation surrounding the tubing and as such there is no requirement for the sealing elements to provide any resistance to the flow of fluids entering the tubing and indeed such elements do not provide any resistance to a reverse in pressure across the casing.

Furthermore, such known sealing elements do not adequately address the problems associated with perforations which have an irregular shape.

The fluids are then routinely transported through ducts or pipes between two remote locations. For example, a pipeline formed of a plurality of pipes connected end to end may connect an offshore drilling operation to an onshore processing facility where the recovered liquid or gas is collected for further processing.

Recovered hydrocarbon fluids are routinely transported at high temperatures and pressures and any opening such as a leak, crack or fracture in the pipeline from the drilling operation to the onshore processing facility can lead to a loss of pressure in the pipeline or a loss of fluid from the pipeline.

It is known to seal leaks in pipes carrying fluids by using remote sealing elements which are deployed upstream of the leak and carried to the leak in the fluid within the pipe. These elements are designed such that they are drawn into the leak and subsequently seal up the leak. The elements are held within the leak by a positive differential pressure across the sealing element. Removal or loss of such a differential internal pressure for example by draining the pipeline compromises the seal as the sealing elements will fall out of the leak site due to gravitational effects.

In underground water pipes, any loss of seal can result in infiltration of particles or groundwater which can contaminate the water carried in the pipe.

Therefore, such known sealing elements are not suitable for use in applications where a reversal of the pressure differential across the leak site can occur. It is not uncommon in subsea pipelines carrying hydrocarbon fluids that when the density of the fluid in the pipeline is less that that of the seawater the pressure in the static head is greater on the outside of the pipeline compared to the inside. In such situations, the pressure differential across a leak is negative and therefore fluid would flow from outside the pipeline, through the leak site thereby dislodging the sealing elements and into the pipeline.

It is therefore an object of the present invention to provide a sealing element which is adapted to resist differential pressure across the leak site whether the higher pressure is applied from within the pipeline or from without.

It is also an object of the present invention to provide a sealing element which is particularly adapted for selective sealing of perforations in well tubing or casing depending upon the physical properties of the fluids being produced from the well and particularly by providing a sealing element which resists back pressure and can seal a perforation from the inside of the tubing thereby preventing the flow of fluid through the perforation from the outside of the tubing.

According to one aspect of the present invention there is provided a sealing element which is adapted to perform partial extrusion through an opening in a pipe wall.

Preferably, the sealing element may be adapted to form a plug on either side of the pipe wall.

In preferred embodiments of the present invention the sealing element may comprise a thixotropic putty.

Preferably the sealing element may be adapted to change state over time. In the preferred embodiments the sealing elements may change from a malleable material capable of a controlled degree of viscous deformation to a solid material preferably with little or no capacity for viscous deformation in response to a triggered event.

Preferably the change of state may be triggered by a change in pressure.

Alternatively, the change of state can be triggered by shear forces acting on the sealing element due to the differential pressure at the leak site.

Alternatively, the change in state can be triggered by a drop or rise in pressure internally or externally of the pipe.

Alternatively, the change in state can be triggered by a change in temperature. The change in temperature may be a rise or fall in temperature over a given time period.

In a further alternative, the change in state can be triggered by a change in physical composition of a material in contact with the sealing element. In one embodiment the sealing element may comprise a swellable material, and most preferably a material which swells on contact with water.

Advantageously the sealing element may comprise a substantially solid core surrounded by an elastomeric body.

Advantageously the core can be formed of a harder material than the body.

Preferably the core may comprise a cured material.

More preferably, the core may comprise a polymer such as polypropylene and nylon, metals such as aluminium, foamed aluminium or rubbers, such as NBR, NR, HNBR or FKM or other elements such as Silicone, TPEs depending upon the sealing requirements.

Conveniently, an outer covering may be provided around the elastomeric body. In preferred embodiments, the outer covering may provide or form a skin around the body of the sealing element.

Advantageously the body may comprise a swellable elastomer material such that swelling of the body, for example upon contact with water or hydrocarbons such as oil or gas, aids the partial extrusion of the sealing element through an opening such as a perforation in a casing wall to provide a self setting action.

Suitable elastomers include water swelling rubber such as cross-linked polyvinyl alcohol, crosslinked polyacrylate, crosslinked starch-acrylate copolymer or a water swellable urethane resin or a hydrophilic group containing rubber. Alternatively the body may comprise or be formed of a cross linked polymer which increases in volume when exposed to an activating agent such a solvent swelling elastomers.

According to a second aspect of the present invention there is provided a method of sealing an opening in a vessel or pipe comprising the steps of introducing a sealing element into the vessel or pipe upstream of the leak, transporting the sealing element to the opening and allowing the sealing element to at least partially extrude through the opening.

Advantageously the sealing element forms a plug on either side of the vessel or pipe wall.

Preferably the sealing element cures as it extrudes through the leak.

Advantageously the sealing element changes states as it extrudes through the leak.

Conveniently the sealing element changes from a malleable semi-viscous state to a solid state preferably with little or no capability for viscous deformation as it extrudes through the leak.

Advantageously the change in state is triggered by a controlled event.

Preferably, the change in state is triggered by a change in pressure, most preferably by a pressure drop internally of the pipe.

Alternatively the change in state is triggered by contact of the sealing element with a substance in the vessel, most preferably water. In one embodiment, the sealing element may swell on contact with water. Swelling of the sealing element within the opening holds the sealing element securely in position and prevents the sealing element from falling out of the opening.

Embodiments of the present invention will now be described with reference to and as shown in the accompanying drawings in which:-

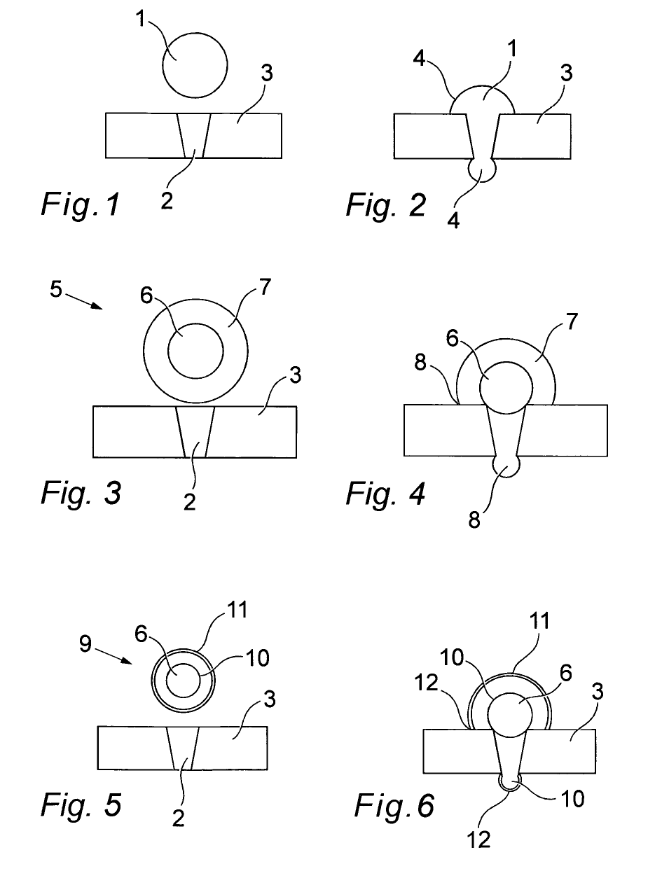

FIG. 1 is a schematic view of a sealing element according to a first embodiment of the present invention as it approaches a leak site;

FIG. 2 is a schematic view of the sealing element of FIG. 1 lodged within the leak site;

FIG. 3 is a schematic view of a sealing element according to a second embodiment of the present invention as it approaches a leak site;

FIG. 4 is a schematic view of the sealing element of FIG. 4 lodged within the leak site;

FIG. 5 is a schematic view of a sealing element according to a third embodiment of the present invention as it approaches a leak site;

FIG. 6 is a schematic view of the sealing element of FIG. 5 lodged within the leak site,

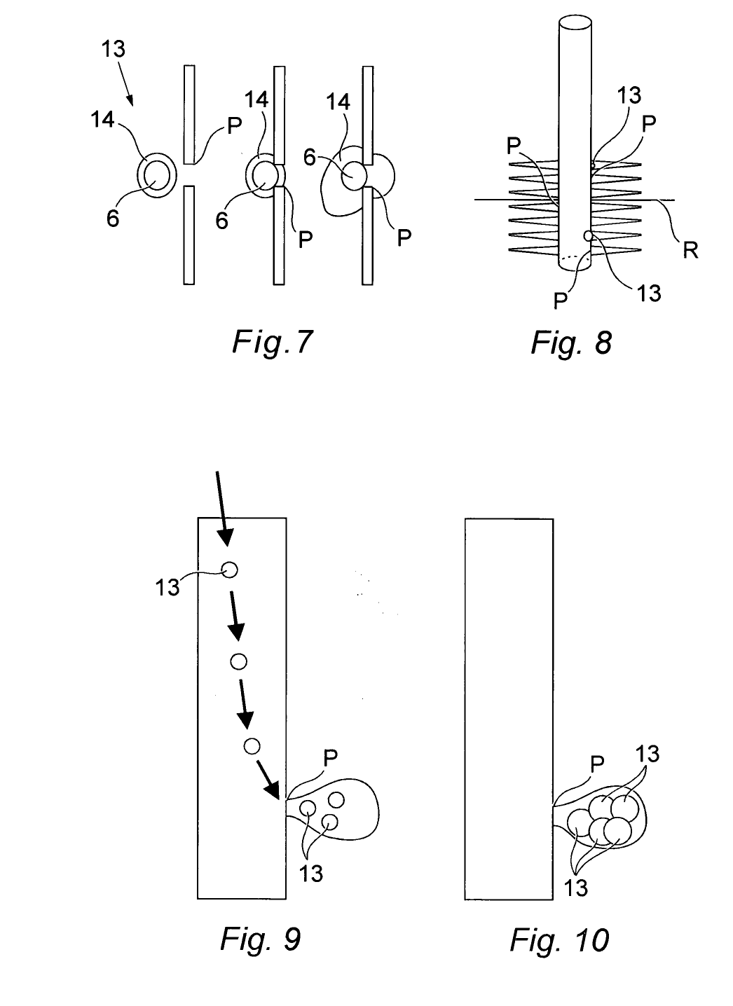

FIG. 7 is a schematic view of a sealing element according to a fourth embodiment of the present invention;

FIG. 8 is a schematic view of the sealing element of FIG. 7 in use sealing a perforation in a downhole environment, and

FIGS. 9 and 10 are schematic views of a further sealing element used in sealing a perforation in a downhole environment.

Turning now to the figures, FIG. 1 is a schematic view of a sealing element 1 according to a first embodiment of the present invention. In this embodiment the sealing element comprises a thixotropic putty which changes state over time from malleable and semi-viscous to substantially solid.

In preferred embodiments, the thixotropic putty may comprise polyurethanes such as 4, 4′ Diphenylmethane Di-isocyanate (M.D.I) with 2-ethyl 1,3 hexane diol as a hardener with about 0.5% silane such as Gamma-glycidoxypropyltrimethoxysilane.

Alternatively, a two part epoxy may be employed such as Diglycidyl ether of bisphenol A (DGEBPA) epoxy resin while the hardener may be a mixture of 2-piperazin-1-ylethylamine and nonyl phenol or Bisphenol A epoxy resin such as ARALDITE® GY 250 while the hardener may be a polyamidoamine based hardener such as Aradur 223 with 1% to 6% organosilane such as AEROSIL® fumed silica added in.

As a further alternative, Epoxidized Natural Rubber based materials may be used which is a natural rubber modified material with some epoxy groups incorporated into it for fluid resistance, examples are ENR-25 (25% epoxy and 75% natural rubber) and ENR 50 (50% epoxy and 50% natural rubber). Other examples include materials which vulcanise and which are deployed in a part cured state, the final cure occurring once the sealing element is in place.

For example, the change in state of the putty may be triggered by physical interaction between the putty and a defect 2 in the side wall 3 of a pipe or vessel such as the sheer forces acting upon the putty as it enters a defect in the pipe wall. Alternatively, the change in state may be triggered by a reaction to a change in environmental conditions such as a change in temperature or pressure.

The sealing element 1 is deployed part way through the cure process such that it undergoes a slow extrusion through the defect 2 whilst completing the curing process to form a plug 4 on either side of the defect. Extrusion of the sealing element through the defect is shown in FIG. 2. The extrusion of the sealing element may be controlled by maintaining the pressure in the system for a given period of time, thus the differential pressure across the sealing element and the extrusion force is controlled.

Once curing of the sealing element 1 is complete as shown in FIG. 2, the sealing element resists further extrusion in either direction into or out of the defect. Therefore any change in direction of the differential pressure across the defect will not unseat the sealing element 1 out of the leak site. Therefore the pipe can be safely drained if required without loss of performance of the seal.

The thixotropic putty displays elastomeric properties which promote a thickening of the extruded portion of the sealing element after it passes through the leak site thereby forming the plug 4 on the outside surface of the pipe wall 2. This gives further back pressure resistance to the sealing element 1 in the cured state. Furthermore, the putty exhibits adhesive properties which encourage the sealing element 1 to bond to the surfaces of the pipe around the defect which further resists removal of the sealing element from the defect once cured.

FIG. 3 illustrates a second embodiment of the invention in which a two part sealing element 5 is employed to seal the leak. In this embodiment the sealing element comprises a relatively hard sealing core 6 of cured material with a relatively soft outer coating 7 applied over the core. Preferably the outer coating is a thixotropic coating as discussed above in relation to the previous embodiment.

The hard inner core may for example comprise a polymer such as polypropylene and nylon, metals such as aluminium, foamed aluminium or rubbers, such as NBR, NR, HNBR, Silicone, TPEs or FKM depending upon the sealing requirements.

The outer coating 7 may comprise materials such as those described in relation to the first embodiment.

As the sealing element 5 approaches the defect the coating 7 extrudes through the defect in the side wall 2 and draws the hard core 6 into sealing engagement within the defect. As the coating cures 7 in position the hard core 6 is prevented from falling out of the leak.

In this embodiment, the hard core 6 of the sealing element is prevented from passing completely through the defect but remains within the leak site.

As with the first embodiment, the extruded coating 7 forms a plug 8 on the outside surfaces of the pipe such that the sealing element 5 extends through the defect on either side of the pipe wall and is retained in position to resist changes in the pressure differential across the defect.

The addition of a core 6 of harder material than the outer coating 7 aids the deployment process as the sealing element 5 is less likely to undergo full extrusion prior to curing of the outer coating.

In some embodiments the coating 7 may undergo a controlled drying or curing process such that the outer surface of the coating drys or cures prior to drying or curing of the remainder of the coating in order to improve handling qualities of the sealing element.

A third embodiment of the present invention is illustrated in FIG. 5 of the drawings. In this embodiment the sealing element 9 is a three part element similar to the second embodiment with a hard inner core 6 and a coating 10 in the form of a curing agent such as a thixotropic putty surrounding the core. In this embodiment an outer skin 11 is provided over the coating 10.

In this embodiment the hard core of the sealing element may be formed by a nylon ball, FKM ball or a polyurethane core. The outer coating may be provided by a sacrificial bag dipped in rubber latex for example.

The outer skin assists in retaining the components of the sealing element together prior to and during deployment.

A two part epoxy such as Bisphenol F epoxy Resin may be suitable while the curing paste may comprise a mixture of polyoxypropyleneamine, tetraethylenepentamine and Diethylenetriamine.

The outer skin may also be formed of other elastomers or polymers or cloth to suit the required properties for sealing and isolation of chemical components. In some cases the skin may be substantial such as a hollow rubber ball. In such cases the skin aids the sealing process whilst in others the skin may be sacrificial and can therefore be less substantial.

As with previous embodiments, the coating 10 extrudes through the defect and completes the curing process once in position within the defect. The outer skin 11 assists in holding the coating 10 around the hard core 6 before the coating 10 extrudes through the defect.

The coating 10 may be a material such as described in relation to earlier embodiments or may be a paste or a variety of liquids or solids. Ideally the coating should set into a hard solid mass with the strength to prevent the sealing element passing through the defect in the side wall of the pipe.

Preferably the core 6 should aid in sealing of the defect whilst the extrusion and curing process occurs.

Preferably the skin 11 is flexible enough to allow for the core 6 to seal an irregular defect.

Preferably the skin 11 is elastomeric to encourage a plug 12 to form on the outer surfaces of the pipe after extruding through the defect.

The skin can be used to add chemical resistance to the mixture.

The skin can be used to provide chemical isolation between the environment of the curing part of the sealing element.

A further embodiment of the present invention is shown in FIGS. 7 and 8 which can be used in sealing an opening such as a defect, hole, fracture, fissure or the like in a pipe as described above but is also particularly adapted for sealing perforations in down hole pipes such as tubing or casing. In this embodiment the sealing element 13 comprises a hard core 6 as described above but the outer coating 14 of the sealing element comprises a swellable material such as but not limited to water swelling rubber such as cross-linked polyvinyl alcohol, crosslinked polyacrylate, crosslinked starch-acrylate copolymer or a water swellable urethane resin or a hydrophilic group containing rubber.

In this embodiment, the change of state of the sealing element is brought about by contact of the sealing element with a suitable material, in this embodiment water. The coating 14 of the sealing element swells to partially extrude through the defect in the pipe wall thereby forming a plug on either side of the pipe wall trapping the central core 6 of the sealing element in position within the defect. The swellable coating provides back pressure resistance as described above.

The sealing element can be removed from the defect when required for example by removing the water from the pipe to cause the swellable material to return to its pre-swollen state such that it can fall out of the defect.

This embodiment is also particularly suitable for use in a downhole environment and particularly in relation to selectively sealing perforations in a well tubing or casing.

As shown in FIG. 8, due to the level of water in the reservoir R surrounding the well, the lower perforations p will be below the water level whilst the upper perforations P are above the water level and therefore hydrocarbons in the well flow through the upper perforations whilst water flows through the lower perforations.

In this embodiment the sealing element 13 is introduced into the casing of the well such as a hydrocarbon producing well. The sealing elements are carried down the casing in an operation generally well known to the skilled person and are drawn to the perforations in the casing. Any sealing elements which land in the perforations below the water level will begin to swell upon contact with water as they extrude through the perforations. As the coating of the element swells, the sealing element becomes locked in position within the perforation and closes off the perforation thereby preventing water from being produced into the casing.

The sealing elements can therefore withstand a back pressure resistance which prevents them from being pushed out of the perforation and back into the tubing and therefore prevents fluids from flowing through the perforations from the formation to the tubing.

In this embodiment, the size core of the sealing elements may be selected such that the sealing elements can pass through the perforations in a pre-swelled condition. Therefore, sealing elements which land in the perforations through which hydrocarbons are being produced, in other words sealing elements which do not come into contact with water, will not undergo a change in state and can therefore pass through the perforations without affecting the fluid production through those perforations.

Alternatively, the platelets which do not swell within the perforations may be removed from the well through a known swabbing operation.

In an alternative embodiment to that described in FIGS. 7 and 8, the outer coating may comprise a cross linked polymer which increases in volume when exposed to an activating agent such a solvent swelling elastomers.

In a further modification shown in FIGS. 9 and 10, the sealing elements as described in FIGS. 7 and 8 are introduced into the tubing as shown in FIG. 9. As before, the sealing elements have a central core which is selected to be of a size which passes through the perforations when the sealing element is in an unswollen condition. The sealing elements are drawn to the perforations in the fluid flow within the tubing as shown in FIG. 9. As before, if during passage through the perforations the sealing elements do not come into contact with water (or some other trigger fluid), then they will not swell within the perforation and will pass into the surrounding formation. In this unswollen state, the sealing elements are unconstrained and/or uncompressed and this allows fluid passage through the spaces or pores between the sealing elements both into and out of the tubing.

However, if once the sealing elements are in the formation they then come into contact with water in the porous formation they undergo a change in state and begin to swell.

As the sealing elements swell, they are constrained by the surrounding formation which causes the sealing elements to deform as they are compressed together thereby closing off the pores or spaces between the sealing elements which stems the flow of fluid between the sealing elements.

Therefore the sealing elements can provide an effective barrier to the ingress of water from the formation into the tubing.

Advantageously the above described embodiments of the present invention provide sealing elements which undergo a partial extrusion through an opening such as a leak, defect or perforation in a pipe wall whilst resisting a complete extrusion through the leak. This results in a sealing element which forms a plug on either side of the leak and resists differential pressure from both sides of the leak site.

Additionally, the use of materials which can change their state over time or selectively upon contact with a chosen material, such as once the extrusion process is completed, is advantageous in that the resistance to differential pressure is significantly increased.

The change of state of the material may be triggered by interaction between the sealing element and the opening in the pipe such as shear forces when the sealing element begins its extrusion through the leak. This provides for controllability of the change in state and ensures that the change in stated occurs at the required time and location.

Alternatively, the change in state may be triggered by a reaction to a change in environmental conditions such as a rise or fall in temperature or pressure. Alternatively the change in state may be triggered by a reaction to stress, strain or external triggers such as UV cure or EM cure.

The sealing elements described are resistant to depressurisation of the line including a full reversal of the pressure in the line and resistant to mechanical intervention such as aggressive pigging in a pipeline or the use of remotely deployed tools to carry out operations within the pipeline.

In each of the above embodiments the sealing element may comprise a time controlled cure material. In alternative embodiments the cure material can be replaced with a non curing material to give modest back pressure resistance. This is particularly useful where there is a need to remove the sealing element at a later date.

In any of the above described embodiments, the portion of the sealing elements which protrude from the wall of the vessel or pipe following partial extrusion, either internally or externally, may be removed, for example with a gauge cutter in order that the sealing element lies substantially flush with the pipe or vessel wall.

It is envisaged that in some circumstances, the bulk density of the sealing elements may be selected to be substantially the same as that of the fluid flowing within the vessel or pipe. Any of the embodiments as described above may be adapted to match the bulk density of the fluid if required.

The present invention has been described with particular reference to the transport of fluids such as hydrocarbons, however it will be appreciated that the present invention also finds application in relation to methods and apparatus for sealing openings such as leaks in vessels and pipelines carrying water such as water injection systems for example, potable water or other fluids including drilling muds or fluids in downhole systems.

1. According to one aspect of the present invention there is provided a sealing element which is adapted to perform partial extrusion through an opening in a pipe wall.

2. A sealing element according to claim 1, wherein the sealing element is adapted to form a plug on either side of the pipe wall.

3. A sealing element according to claim 1 or 2, wherein the sealing element comprises a thixotropic putty.

4. A sealing element according to any of the preceding claims, wherein the sealing element is adapted to change state over time.

5. A sealing element according to claim 4, wherein the sealing element changes from a malleable semi-viscous material to a solid material in response to a triggered event.

6. A sealing element according to claim 5, wherein the change of state is triggered by a change in pressure.

7. A sealing element according to claim 5, wherein the change of state is triggered by shear forces acting on the sealing element due to the differential pressure at the leak site.

8. A sealing element according to claim 6, wherein the change in state is triggered by a drop in pressure internally of the pipe.

9. A sealing element according to claim 5, wherein the change in state is triggered by a change in temperature.

10. A sealing element according to claim 5, wherein the change in state is triggered by contact of the sealing element with a material or substance within the vessel.

11. A sealing element according to claim 10, wherein the change in state is triggered by contact of the sealing element with water.

12. A sealing element according to claim 9, wherein the change in temperature is controlled over a given time period.

13. A sealing element according to any of the preceding claims, wherein the sealing element comprises a substantially solid core surrounded by an elastomeric body.

14. A sealing element according to claim 11, wherein the core is formed of a harder material than the body.

15. A sealing element according to claim 12, wherein the core comprises a cured material.

16. A sealing element according to claim 13, wherein the core comprises polymers, metals, foamed aluminium or rubbers.

17. A sealing element according to claim 13, wherein the body comprises a swellable elastomer material.

18. A sealing element according to any of claims 11-17, wherein an outer covering may be provided around the elastomeric body.

19. A sealing element substantially as hereinbefore described with reference to or as shown in any of FIGS. 1-8 of the accompanying drawings.

20. A method of sealing an opening in a vessel or pipe comprising the steps of introducing a sealing element into the vessel or pipe upstream of the leak, transporting the sealing element to the opening and allowing the sealing element to at least partially extrude through the opening.

21. A method according to claim 20, wherein the sealing element cures to form a plug on either side of the vessel or pipe wall.

22. A method according to claim 21, wherein the sealing element cures as it extrudes through the leak.

23. A method according to any of claims 20-22, wherein the sealing element changes states as it extrudes through the leak.

24. A method according to claim 22, wherein the sealing element changes from a malleable state to a solid state as it extrudes through the leak.

25. A method according to claim 23 or 24, wherein the change in state is triggered by a controlled event.

26. A method according to claim 25, wherein the change in state is triggered by a change in pressure.

27. A method according to claim 25 wherein the change in state is triggered by a change in temperature.

28. A method according to claim 25 wherein the change in state is triggered by shear forces acting on the sealing element as it extrudes through the leak.

29. A method according to claim 25, wherein the change in state is triggered by contact of the sealing element with a material or substance in the vessel.

30. A method according to claim 29 wherein, the change in state is triggered by contact of the sealing element with water.

31. A method according to claim 30, wherein the sealing element swells upon contact with water.

31. A method of sealing an opening in a vessel or pipe substantially as hereinbefore described.
